(19) United States
(12) Patent Application Publication
(10) Pub. No.: US 2012/0296960 A1
(43) Pub. Date: Nov. 22, 2012

(54) METHOD AND SYSTEM FOR PROVIDING ACCESS TO MAINFRAME DATA OBJECTS IN A HETEROGENEOUS COMPUTING ENVIRONMENT

(75) Inventors: Leonid Kreuzer, Butzbach (DE); Yuri Vizitei, Columbia, MO (US)

(73) Assignee: Roundtrip Systems Inc., Columbia, MO (US)

(21) Appl. No.: 13/474,360

(22) Filed: May 17, 2012

Related U.S. Application Data
(60) Provisional application No. 61/487,142, filed on May 17, 2011.

(51) Int. Cl. G06F 15/16

(52) U.S. Cl. 709/203

(57) ABSTRACT

A method for providing access to mainframe data objects in a heterogeneous computing environment includes providing, by a non-mainframe server, a service comprising a storage virtualization system for storing mainframe data in a virtual storage device. The mainframe data is managed by a mainframe server, which is connected to a physical storage device and to the server so that the virtual storage device in the storage virtualization system appears as another physical storage device to the mainframe server. The method includes receiving, by the server, a message from a non-mainframe client connected to the server via a network, wherein the virtual storage device appears as a mounted storage drive to the client, and the message includes a request for access to the mounted storage drive and/or to data stored therein. The request is processed to generate a non-mainframe formatted request result, which is transmitted to the client via the network.

### CLAIM OF PRIORITY

This application claims the benefit of U.S. Provisional Patent Application 61/487,142, entitled, “Mainframe Storage Appliance (MSA),” filed May 17, 2011 (Attorney Docket No. 1368.02PRO), the entire contents of which are incorporated herein by reference.

### BACKGROUND

One of the oldest, yet recurring, business problems is the incompatibility between modern storage systems and legacy mainframe storage systems and legacy storage devices, and accessing data stored in those systems. This incompatibility plagues business environments and adds undue cost, risk and time to the development of system maintenance and new system development. New systems are rarely isolated stand-alone technologies. The sophistication demanded by modern enterprise information technology necessitates seamless data integration in real time and at a reasonable cost. While serving a specific purpose, current storage systems are likely to have to provide data to, or retrieve data from, existing legacy mainframe storage systems and applications. Likewise, legacy mainframe storage systems and applications have critical and often strategic data that is difficult, costly or even impossible to access via a non-mainframe system. In both instances, data integration is nearly impossible without the development of specific data interfaces, information exchange subsystems or some other custom software application, all with the associated risk, cost and time implications.

For some legacy mainframe systems and applications, the knowledge and expertise to manage those systems may no longer be available, not least because personnel having such knowledge and expertise are no longer available. Moreover, the necessary mainframe software tools may not be available and/or are too costly to obtain. To make matters worse, the existing mainframe computing environment may not have the capacity and/or spare cycles to perform additional data processing, data transfers, or the like. In some cases, mainframe systems currently in operation, lack matching source code to enable modifications or further development of the solution.

### BRIEF DESCRIPTION OF THE DRAWINGS

Advantages of the subject matter claimed will become apparent to those skilled in the art upon reading this description in conjunction with the accompanying drawings, in which like reference numerals have been used to designate like elements, and in which:

FIG. 1 is a block diagram illustrating an exemplary hardware device in which the subject matter may be implemented;

FIG. 2 is a flow diagram illustrating an exemplary method for providing access to mainframe data objects in a heterogeneous computing environment according to an exemplary embodiment;

FIG. 3 is a block diagram illustrating an exemplary system for providing access to mainframe data objects in a heterogeneous computing environment according to an exemplary embodiment;

FIG. 4 is a block diagram illustrating a data structure representing an exemplary file system index according to an exemplary embodiment; and

FIG. 5 is a block diagram illustrating a network in which a system for providing access to mainframe data objects in a heterogeneous computing environment can be implemented.

### DETAILED DESCRIPTION

The subject matter presented herein provides for access to mainframe data objects in a heterogeneous computing environment. According to an embodiment, a mainframe storage appliance (MSA) service is provided that allows access to mainframe data objects by both non-mainframe based utilities and applications running on non-mainframe client computer nodes and by mainframe utilities running on a mainframe computer node. In an embodiment, the MSA service operates in a non-mainframe computing environment in a server node that is communicatively coupled to the mainframe computer, which in turn is coupled to physical mainframe storage devices such as tape drives and disk drives. The MSA service provides a storage virtualization system that stores mainframe data objects in virtual storage devices that appear as physical mainframe storage devices to the mainframe computer. In other words, from the mainframe computer's perspective, the virtual storage devices look like a rack of standard DASD or tape drives, which can be used to store any type of data via any data access method supported by the mainframe computer's operating system. Accordingly, the MSA service allows the mainframe computer to store mainframe data objects in the virtual storage devices in a non-mainframe computing environment.

In addition to providing an alternative data storage medium for the mainframe data objects, the MSA service also makes the mainframe data objects stored in the virtual storage devices available for consumption by non-mainframe client computer nodes on a network of non-mainframe compatible servers and applications. In an embodiment, the server node hosting the MSA service is connected to non-mainframe client computer nodes via a network, e.g., a TCP/IP network over a Ethernet backbone. In an embodiment, the virtual storage devices in the storage virtualization system appear as mounted storage drives to the client computer nodes and the stored mainframe data objects are represented as folders and/or files. In order to provide access to the mainframe data object “files,” the MSA service is configured to convert mainframe data objects from their native mainframe compatible format to another format compatible with the client computer nodes. Accordingly, the MSA service allows the non-mainframe client computer to open, view and retrieve mainframe data objects quickly and easily using standard non-mainframe utilities and applications and the mainframe's own high speed communication channels.

In another embodiment, the MSA service is communicatively coupled to a physical mainframe storage device such as a tape drive and/or a disk drive, and is configured to provide the data objects stored in the physical mainframe storage device for consumption to a non-mainframe client computer node on the network. In an embodiment, the physical mainframe storage device appears as an additional mounted storage drive to the client computer node and the stored mainframe data objects in the device can be represented as folders and/or files. In order to provide access to those mainframe data object “files,” the MSA service is configured to receive an access request from the client computer node, to submit mainframe compatible instructions corresponding to the access request to the physical mainframe storage device, and to receive mainframe data object(s) satisfying the request. The MSA service then converts the mainframe data object(s) from its native mainframe compatible format to another format compatible with the client computer node, and transmits the result to the client computer node. Accordingly, in this embodiment, the MSA service allows the non-mainframe client computer to open, view and retrieve archived mainframe data objects that are stored in legacy mainframe storage devices using standard non-mainframe utilities and applications.

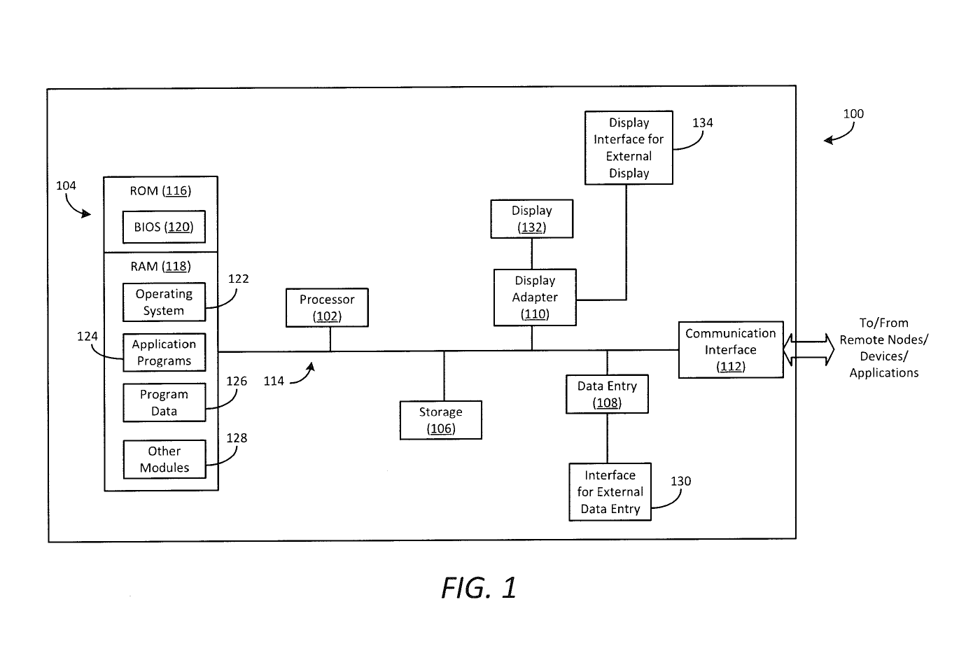

Prior to describing the subject matter in detail, an exemplary hardware device in which the subject matter may be implemented shall first be described. Those of ordinary skill in the art will appreciate that the elements illustrated in FIG. 1 may vary depending on the system implementation. With reference to FIG. 1, an exemplary system for implementing the subject matter disclosed herein includes a hardware device 100, including a processing unit 102, memory 104, storage 106, data entry module 108, display adapter 110, communication interface 112, and a bus 114 that couples elements 104-112 to the processing unit 102.

The bus 114 may comprise any type of bus architecture. Examples include a memory bus, a peripheral bus, a local bus, etc. The processing unit 102 is an instruction execution machine, apparatus, or device and may comprise a microprocessor, a digital signal processor, a graphics processing unit, an application specific integrated circuit (ASIC), a field programmable gate array (FPGA), etc. The processing unit 102 may be configured to execute program instructions stored in memory 104 and/or storage 106 and/or received via data entry module 108.

The memory 104 may include read only memory (ROM) 116 and random access memory (RAM) 118. Memory 104 may be configured to store program instructions and data during operation of device 100. In various embodiments, memory 104 may include any of a variety of memory technologies such as static random access memory (SRAM) or dynamic RAM (DRAM), including variants such as dual data rate synchronous DRAM (DDR SDRAM), error correcting code synchronous DRAM (ECC SDRAM), or RAMBUS DRAM (RDRAM), for example. Memory 104 may also include nonvolatile memory technologies such as nonvolatile flash RAM (NVRAM) or ROM. In some embodiments, it is contemplated that memory 104 may include a combination of technologies such as the foregoing, as well as other technologies not specifically mentioned. When the subject matter is implemented in a computer system, a basic input/output system (BIOS) 120, containing the basic routines that help to transfer information between elements within the computer system, such as during start-up, is stored in ROM 116.

The storage 106 may include a flash memory data storage device for reading from and writing to flash memory, a hard disk drive for reading from and writing to a hard disk, a magnetic disk drive for reading from or writing to a removable magnetic disk, and/or an optical disk drive for reading from or writing to a removable optical disk such as a CD ROM, DVD or other optical media. The drives and their associated computer-readable media provide nonvolatile storage of computer readable instructions, data structures, program modules and other data for the hardware device 100.

It is noted that the methods described herein can be embodied in executable instructions stored in a computer readable medium for use by or in connection with an instruction execution machine, apparatus, or device, such as a computer-based or processor-containing machine, apparatus, or device. It will be appreciated by those skilled in the art that for some embodiments, other types of computer readable media may be used which can store data that is accessible by a computer, such as magnetic cassettes, flash memory cards, digital video disks, Bernoulli cartridges, RAM, ROM, and the like may also be used in the exemplary operating environment. As used here, a “computer-readable medium” can include one or more of any suitable media for storing the executable instructions of a computer program in one or more of an electronic, magnetic, optical, and electromagnetic format, such that the instruction execution machine, system, apparatus, or device can read (or fetch) the instructions from the computer readable medium and execute the instructions for carrying out the described methods. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

A number of program modules may be stored on the storage 106, ROM 116 or RAM 118, including an operating system 122, one or more applications programs 124, program data 126, and other program modules 128. A user may enter commands and information into the hardware device 100 through data entry module 108. Data entry module 108 may include mechanisms such as a keyboard, a touch screen, a pointing device, etc. Other external input devices (not shown) are connected to the hardware device 100 via external data entry interface 130. By way of example and not limitation, external input devices may include a microphone, joystick, game pad, satellite dish, scanner, or the like. In some embodiments, external input devices may include video or audio input devices such as a video camera, a still camera, etc. Data entry module 108 may be configured to receive input from one or more users of device 100 and to deliver such input to processing unit 102 and/or memory 104 via bus 114.

A display 132 is also connected to the bus 114 via display adapter 110. Display 132 may be configured to display output of device 100 to one or more users. In some embodiments, a given device such as a touch screen, for example, may function as both data entry module 108 and display 132. External display devices may also be connected to the bus 114 via external display interface 134. Other peripheral output devices, not shown, such as speakers and printers, may be connected to the hardware device 100.

The hardware device 100 may operate in a networked environment using logical connections to one or more remote nodes (not shown) via communication interface 112. The remote node may be another computer, a server, a router, a peer device or other common network node, and typically includes many or all of the elements described above relative to the hardware device 100. The communication interface 112 may interface with a wireless network and/or a wired network. Examples of wireless networks include, for example, a BLUETOOTH network, a wireless personal area network, a wireless 802.11 local area network (LAN), and/or wireless telephony network (e.g., a cellular, PCS, or GSM network). Examples of wired networks include, for example, a LAN, a fiber optic network, a wired personal area network, a telephony network, and/or a wide area network (WAN). Such networking environments are commonplace in intranets, the Internet, offices, enterprise-wide computer networks and the like. In some embodiments, communication interface 112 may include logic configured to support direct memory access (DMA) transfers between memory 104 and other devices.

In a networked environment, program modules depicted relative to the hardware device 100, or portions thereof, may be stored in a remote storage device, such as, for example, on a server. It will be appreciated that other hardware and/or software to establish a communications link between the hardware device 100 and other devices may be used.

It should be understood that the arrangement of hardware device 100 illustrated in FIG. 1 is but one possible implementation and that other arrangements are possible. It should also be understood that the various system components (and means) defined by the claims, described below, and illustrated in the various block diagrams represent logical components that are configured to perform the functionality described herein. For example, one or more of these system components (and means) can be realized, in whole or in part, by at least some of the components illustrated in the arrangement of hardware device 100. In addition, while at least one of these components are implemented at least partially as an electronic hardware component, and therefore constitutes a machine, the other components may be implemented in software, hardware, or a combination of software and hardware. More particularly, at least one component defined by the claims is implemented at least partially as an electronic hardware component, such as an instruction execution machine (e.g., a processor-based or processor-containing machine) and/or as specialized circuits or circuitry (e.g., discrete logic gates interconnected to perform a specialized function), such as those illustrated in FIG. 1. Other components may be implemented in software, hardware, or a combination of software and hardware. Moreover, some or all of these other components may be combined, some may be omitted altogether, and additional components can be added while still achieving the functionality described herein. Thus, the subject matter described herein can be embodied in many different variations, and all such variations are contemplated to be within the scope of what is claimed.

In the description that follows, the subject matter will be described with reference to acts and symbolic representations of operations that are performed by one or more devices, unless indicated otherwise. As such, it will be understood that such acts and operations, which are at times referred to as being computer-executed, include the manipulation by the processing unit of data in a structured form. This manipulation transforms the data or maintains it at locations in the memory system of the computer, which reconfigures or otherwise alters the operation of the device in a manner well understood by those skilled in the art. The data structures where data is maintained are physical locations of the memory that have particular properties defined by the format of the data. However, while the subject matter is being described in the foregoing context, it is not meant to be limiting as those of skill in the art will appreciate that various of the acts and operation described hereinafter may also be implemented in hardware.

To facilitate an understanding of the subject matter described below, many aspects are described in terms of sequences of actions. At least one of these aspects defined by the claims is performed by an electronic hardware component. For example, it will be recognized that the various actions can be performed by specialized circuits or circuitry, by program instructions being executed by one or more processors, or by a combination of both. The description herein of any sequence of actions is not intended to imply that the specific order described for performing that sequence must be followed. All methods described herein can be performed in any suitable order unless otherwise indicated herein or otherwise clearly contradicted by context.

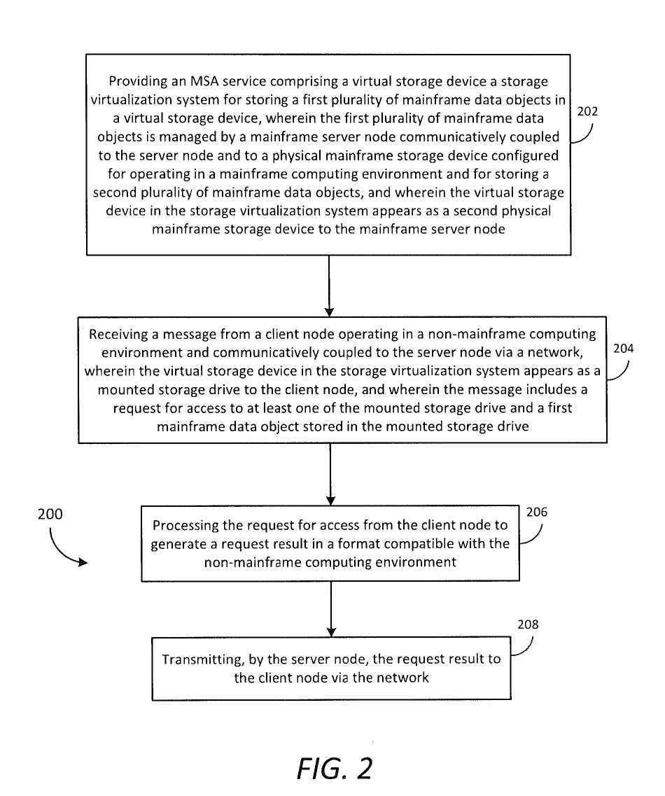

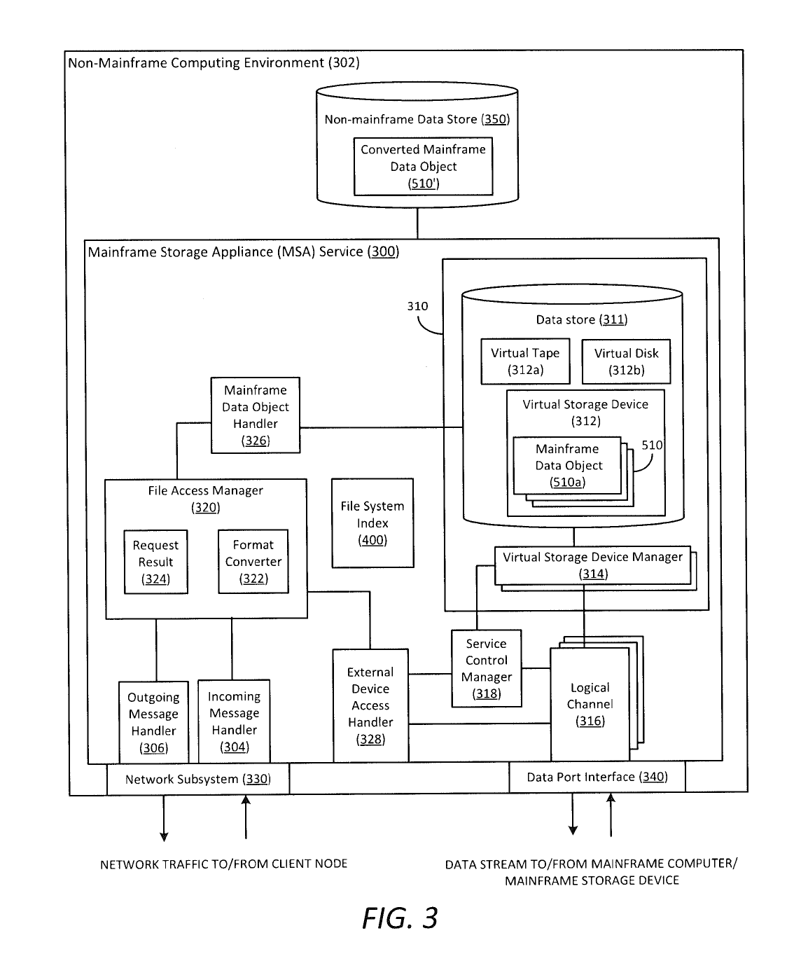

Referring now to FIG. 2, a flow diagram is presented illustrating a method 200 for providing access to mainframe data objects in a heterogeneous computing environment according to an exemplary embodiment. FIG. 3 is a block diagram illustrating an exemplary system for providing access to mainframe data objects in a heterogeneous computing environment according to embodiments of the subject matter described herein. The method 200 illustrated in FIG. 2 can be carried out by, for example, at least some of the components in the exemplary arrangement of components illustrated in FIG. 3. The arrangement of components in FIG. 3 may be implemented by some or all of the components of the hardware device 100 of FIG. 1.

FIG. 3 illustrates components that are configured to operate within a computing environment hosted by a computer device and/or multiple computer devices, as in a distributed computing environment. For example, FIG. 5 illustrates a standard mainframe system that includes a mainframe server node 503 that is directly coupled to at least one physical mainframe storage device 501a, 501b, where each physical storage device 501a, 501b stores mainframe data objects 510 managed by the mainframe server node 503. Also illustrated in FIG. 5 is a plurality of computer nodes 500, 502, communicatively coupled to one another via a network 504, such as a wired or wireless LAN or WAN. In an embodiment, the server node 502 can be configured to provide a computing environment configured to support the operation of the components illustrated in FIG. 3 and/or their analogs. Exemplary computer nodes can include physical or virtual desktop computers, servers, networking devices, notebook computers, PDAs, mobile phones, digital image capture devices, and the like.

With reference to FIG. 2, in block 202, a mainframe storage appliance (MSA) service 300 is provided by a server node operating in a non-mainframe computing environment. The MSA service comprises a storage virtualization system for storing a first plurality of mainframe data objects in a virtual storage device. The first plurality of mainframe data objects is managed by a mainframe server node communicatively coupled to the server node and to a physical mainframe storage device configured for operating in a mainframe computing environment and for storing a second plurality of mainframe data objects. In an embodiment, the virtual storage device in the storage virtualization system appears as a second physical mainframe storage device to the mainframe server node.

Illustrated in FIG. 3 is an MSA service 300 including components adapted for operating in a non-mainframe computing environment 302. In an embodiment, the non-mainframe computing environment can be any of a number of computing platforms, including but not limited to, a desktop computing environment, a mobile computing environment, and a cloud computing environment. The non-mainframe computing environment 302, or an analog, can be provided by a computer device such as the server node 502.

In an embodiment, the storage virtualization system 310 can include a data store 311, and the MSA service 300 can be configured to set up one or more virtual storage devices 312, 312a, 312b in the data store 311. A virtual storage device 312 can represent any mainframe storage device such as a disk drive, a tape drive, a printer, a terminal, or any device that can be configured to store or transmit mainframe data objects 510. In an embodiment, the storage virtualization system 310 can include at least one virtual storage device manager component 314 that can be configured to set up, access, and manage at least one virtual storage device 312. A virtual storage device manager 314, in an embodiment, can be configured to manage different threads for a particular type of virtual storage device, e.g., a virtual tape device 312a. For example, the virtual storage device manager 314 can define data areas, i.e., control blocks, for each virtual storage device 312, can detect the type of the virtual device 312, e.g., disk, tape, and can load appropriate software modules, e.g., a DLL.

According to an embodiment, the MSA service 300 is communicatively coupled to the mainframe server node 503 via a data port interface 340. For example, the MSA service 300 can connect to the mainframe server node 503 via a communication device or generated data stream that is compliant with standard fiber channel interface protocol, e.g., FICON, or other standards such as ESCON or SCSI. Once connected, the virtual storage devices 312 of the MSA service 300 appear to the mainframe server node 503 as a newly installed rack of physical mainframe storage or output devices like those 501a, 501b described above, that can be used to store or output mainframe data objects 510.

In an embodiment, the MSA service 300 can be configured to establish a logical channel 316 that communicatively connects a virtual storage or output device 312 to the mainframe server node 503 via the virtual storage device manager 314 managing the virtual storage device 312. According to an embodiment, the MSA service 300 can include a service control manager component 318, which when invoked, can be configured to set up or break down a logical channel 316 and to monitor all traffic travelling within a logical channel 316. The service control manager component 318 can be configured to manage multiple logical channels 316 as well as multiple communication sessions within a single logical channel 316.

In an embodiment, when a mainframe command from the mainframe server node 503 is received by the MSA service 300 in the server node 502, and the command relates to a mainframe data object 510 to be stored in, output to, or retrieved from a virtual storage device 312, the logical channel 316 can be configured to route the command to the virtual storage device manager 314 associated with the virtual storage device 312. When the command is received, the device manager 314 can be configured to process the command to store or retrieve the mainframe data object 510 in or from the virtual storage device 312. Although the data objects 510 are stored in a virtual storage device 312 in a non-mainframe computing environment 302, they are stored in their native mainframe compatible format. This is so because the mainframe server node 503 is configured to utilize only mainframe applications and utilities to manage the mainframe data objects 510.

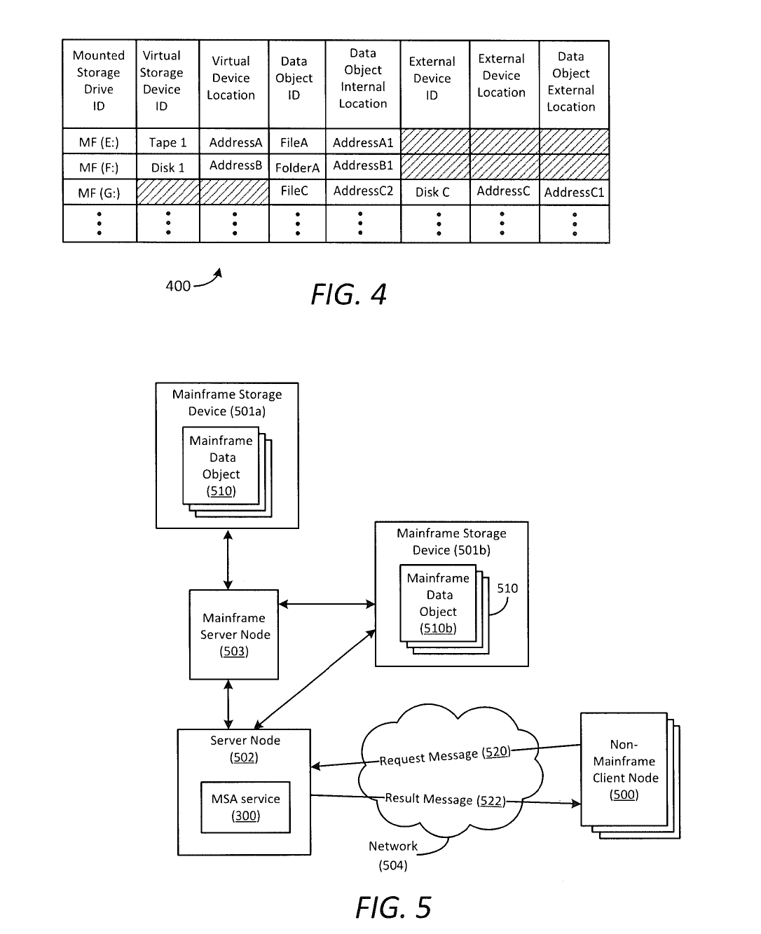

According to an embodiment, when the MSA service 300 is provided, a file system index 400 can be generated that records information relating to the virtual storage devices 312 and to the mainframe data objects 510 stored in those virtual storage devices 312 and associated with the storage virtualization system 310. For example, FIG. 4 illustrates an exemplary data structure that can represent the file system index 400 in an embodiment. In this embodiment, the file system index 400 can be a table that includes information identifying the virtual storage devices 312, 312a, 312b, and/or each of the mainframe data objects 510 stored in each virtual storage device 312, 312a, 312b. In addition, the data structure representing the file system index 400 can include a storage location of each virtual storage device 312, 312a, 312b, and of each mainframe data object 510. Accordingly, when a new mainframe data object 510 is stored in one of the virtual storage devices 312, 312a, 312b, the virtual device manager component 314 associated with the modified virtual storage device 312 can be configured to update the file system index 400 to include information identifying the new data object 510 and its storage location.

Referring again to FIG. 2, in block 204, a message is received by the server node 502 from a client node 500 operating in a non-mainframe computer environment and communicatively coupled to the server node 502 via the network 504. In an embodiment, when the MSA service 300 is provided and the virtual storage devices 312, 312a, 312b are defined, the virtual storage devices 312, 312a, 312b in the storage virtualization system 300 appear as mounted storage drives to the client node 500. According to an embodiment, the message 520 includes a request for access to a mounted storage drive, and/or a first mainframe data object stored in the mounted storage drive.

According to an embodiment, when the server node 502 is connected to the network 504, e.g., via an Ethernet cable, the MSA service 300 can expose the virtual storage devices 312, 312a, 312b and their contents to the client nodes 500 connected to the network 504. In an embodiment, the contents of the virtual storage devices 312, 312a, 312b can be presented to the client node 500 in the form of shared directories supported by many popular non-mainframe utilities and applications. From the perspective of the client node 500, the storage devices 312, 312a, 312b are mounted drives and the contents are data objects, such as folders and files. Accordingly, the request message 520 can include information identifying a mounted storage drive and/or information identifying a data object stored in the mounted storage drive. In addition, the request message 520 can include a command that defines the type of access requested. For example, the command can be related to opening a drive to reveal its contents, to reading a data object in a mounted drive; or to updating a data object in a mounted drive.

The MSA service 300 can be configured, in an embodiment, to receive information from the client nodes 500 over the network 504 via a network subsystem 330 and an application protocol layer 332, or other higher protocol layer. These higher protocol layers can encode, package, and/or reformat data for sending and receiving messages over a network layer, such as Internet Protocol (IP), and/or a transport layer, such as Transmission Control Protocol (TCP). A file access manager component 320 in the MSA service 300 can be configured to receive the message 520 from the client node 500 over the network 504 and via the network subsystem 330 and an incoming message handler 304.

Referring again to FIG. 2, when the request message 520 is received, it is processed to generate a request result in a format compatible with the non-mainframe computing environment in block 206. According to an embodiment, the file access manager component 320 can be configured to process the request for access from the client node 500 to generate the request result 324 in a format compatible with the non-mainframe computing environment.

As state above, the request message 520 from the client node 500 can include information identifying a mounted storage drive and/or information identifying a data object stored in the mounted storage drive. In an embodiment, the type of storage device, e.g., disk or tape, is irrelevant to the client node 500, and information identifying the mounted drive, e.g., Drive (E:), can be different from information identifying the corresponding storage device 312 in the storage virtualization system 310. Accordingly, in an embodiment, when a virtual storage device 312 is created, the file system index 400 can be updated to include information correlating information identifying a mounted storage drive to information identifying the corresponding virtual storage device 312.

When the file access manager component 320 receives the request message 520, the information identifying the mounted drive can be extracted, in an embodiment, and the file access manager component 320 can refer to the file system index 400 to identify a storage location associated with the virtual storage device 312 corresponding to the mounted storage drive and/or a storage location associated with the first mainframe data object 510a.

According to an embodiment, once the storage location is identified, the file access manager component 320 can be configured to route the request and the storage location to a mainframe data object handler component 326 in the MSA service 300. As stated above, the request can include a command related to how the virtual storage device 312 and/or data object 510a is to be accessed. In an embodiment, the mainframe data object handler component 326 is configured to locate the virtual storage device 312 and/or the first mainframe data object 510a and to perform the command. For example, when the request includes a command to read the first mainframe data object 510a, the mainframe data object handler component 326 can be configured to retrieve the first mainframe data object 510a from the identified storage location, and to return it to the file access manager component 320. Alternatively, when request includes a command to replace the first mainframe data object 510a with an updated mainframe data object, the mainframe data object handler component 326 can be configured to locate the first mainframe data object 510a, and to replace it with the updated data object. In an embodiment, the file system index 400 can be updated if needed.

According to an embodiment, when the command has been performed, the file access manager component 320 is configured to generate a request result 324 in a format that is compatible with the non-mainframe computing environment of the client node 500. Depending on the command performed, the request result 324 can include a message indicating the status of the command, e.g., pending, completed, error, and/or the retrieved mainframe data object 510a. As stated above, the mainframe data objects 510 stored in the virtual storage devices 312 are stored in their native mainframe format, e.g., EBCDIC. Accordingly, when a mainframe data object 510 is retrieved and provided to the file access manager component 320, it cannot be accessed by a non-mainframe application. Similarly, when a mainframe data object is received from a non-mainframe application running on the client node 500, e.g., the updated data object, it cannot be access by a mainframe utility or application.

In an embodiment, when the file access manager component 320 receives a data object from the mainframe data object handler component 326, e.g., the retrieved first mainframe data object 510a, the file access manager component 320 can be configured to convert the data object 510a from a first format compatible with the mainframe computing environment to a second format compatible with the non-mainframe computing environment of the client node 500. Similarly, when the file access manager component 320 receives a data object from the client node 500, e.g., an updated data object, it can be configured to convert the data object from the second format compatible with the non-mainframe computing environment to the first format compatible with the mainframe computing environment of the mainframe server node 503.

In an embodiment, the file access manager component 320 can include a format converter 322, which when invoked, can automatically map data in the first format to data in the second format and vice versa. For example, a VSAM mainframe formatted file can be converted to a comma-delimited or tab-delimited non-mainframe formatted file that is accessible to non-mainframe utilities, e.g., MS Excel, MS Access. In another example, a BPAM mainframe formatted file can be converted into a library of files and presented as a nested directory structure to the client node 500. The following types of datasets exist today in the modern mainframe environment:
VSAM
Extended VSAM
Sequential (DASD and TAPE)
Extended Sequential
Large Sequential
Datasets in EAV space
Partitioned datasets (PDS)
Partitioned datasets extended (PDS/E)
Unix system services datasets (HFS and ZFS)
   In an embodiment, mapping can be provided for DASD and TAPE sequential datasets, and DASD Partitioned datasets (PDS, PDS/E). Other datasets can be “visible” as binary and can still be accessed, although without any “logical mapping” of their internal structure.

Once the first mainframe data object is converted to a format compatible with the non-mainframe computing environment, the file access manager component 320 can be configured to include the converted mainframe data object 510a in the request result 324. Similarly, once the updated data object is converted to a format compatible with the mainframe computing environment, the converted data object can then be transmitted to the mainframe data object handler component 326, which then replaces the first mainframe data object 510a with the converted data object in a virtual storage device 312.

Referring again to FIG. 2, when the request result 324 is generated, the MSA service 300 is configured to transmit the request result 324 to the client node 500 via the network 504 in block 208. In an embodiment, the file access manager component 320 can be configured to provide the request result 324 to an outgoing message handler 306 in the MSA service 300. In an embodiment, the outgoing message handler 306 can be configured to build a result message 522 including the request result 324 and to interoperate directly with the protocol layer of the network subsystem 330 or with an application protocol layer 332. The result message 522 including the request result 324 can be transmitted as a whole or in parts via the network subsystem 330 over the network 504 to the client node 500a.

In the embodiments described, the MSA service 300 is configured to provide a virtual storage solution that accommodates heterogeneous computing environments with data sharing needs. In an embodiment, client nodes 500 operating in a non-mainframe computing environment can utilize non-mainframe applications and utilities to monitor, view and export mainframe data objects 510 from the virtual mainframe storage devices 312, 312a, 312b created by the MSA service 300. Accordingly, critical mainframe data objects can be accessed without utilizing mainframe utilities and resources, which can be costly and scarce. Moreover, because the mainframe data objects 510 stored in the storage virtualization system 310 are easily exported and relatively inexpensive to access, customers who use mainframe emulators and who perform mainframe based research and development (R&D) projects, program testing, and quality assurance (QA) functions can do so efficiently and for lower cost.

In addition to the embodiments described above, the MSA service 300 can also be configured to connect directly to a physical mainframe storage device 501b to provide additional functionality. For example, when the mainframe server node 503 is no longer being utilized, archived mainframe data objects stored in physical mainframe storage devices 501a, 501b can be accessed directly by the MSA service 300 and costly efforts to extract the archived information using mainframe utilities and resources can be avoided.

According to an embodiment, the MSA service 300 can be communicatively coupled to a physical mainframe storage device 501a via the data port interface 340. For example, the MSA service 300 can connect to the storage device 501a via a communication device compliant with standard fiber channel interface protocol, e.g., FICON, and other mainframe protocols such as ESCON and SCSI. Once connected, the MSA service 300 appears to the physical mainframe storage device 501a as a mainframe server node from which the storage device 501a can receive commands to access the mainframe data objects 510 stored therein. In addition, from the perspective of the client node 500 connected to the server node 502 over the network 504, the mainframe storage device 501a appears as a new mounted storage drive when it is connected to the server node 502. To the client node 500, this “new” storage drive is not a legacy mainframe storage device 501a. Rather, it appears as a standard drive that is accessible using non-mainframe utilities and applications.

In an embodiment, the file system index 400 can be updated to include information identifying the physical mainframe storage device 501a, each of the second plurality of mainframe data objects 510 stored therein, a storage location of the device 501a, and/or a storage location of each of the second plurality of mainframe data objects 510. In addition, the file system index 400 can include information correlating the second mounted storage drive to the physical mainframe storage device 501a. For example, in FIG. 4, the exemplary file system index 400 indicates that a mounted storage drive identified as “MF (G:)” corresponds to a physical storage device identified as “Disk C,” located at “AddressC.”

According to an embodiment, the MSA service 300 can receive another message from the client node 500 that includes a request for access to the second mounted storage drive and/or a second mainframe data object 510b stored in the second mounted storage drive. As before, the request message 520 can include information identifying the second mounted storage drive and/or information identifying the second mainframe data object stored in the second mounted storage drive. The file access manager component 320 can be configured to receive the second request message 520 from the client node 500 over the network 504 and via the network subsystem 330 and the incoming message handler 304.

As described above, when the file access manager component 320 receives the request message 520, it processes the request by extracting the information identifying the second mounted drive, in an embodiment, and by referring to the file system index 400 to identify a storage device, e.g., 501a, corresponding to the second mounted drive, and identifying a storage location associated with the identified storage device 501a and/or a storage location associated with the second mainframe data object 510b. In this embodiment, because the identified storage location is external to the server node 502, the file access manager component 320 can be configured to route the second request and the storage location(s) to an external device access handler component 328 in the MSA service 300.

According to an exemplary embodiment, the external device access handler component 328 can be configured to manage requests from client nodes 500 to access physical mainframe storage devices 501a, 501b, such as standalone disk drives and tape drives, and mainframe data objects 510 stored therein. As stated above, a request to access can include a command related to how the physical storage device 501a and/or second mainframe data object 510b is to be accessed. In an embodiment, when the second request and the identified storage location(s) are received, the external device access handler component 328 can be configured to locate the identified storage device 501a and/or the second mainframe data object 510b in the identified storage device 501a and to perform the command.

In an embodiment, instructions to perform the command can differ depending on the type of mainframe storage device is being accessed. For example, when the request includes a command to read the second mainframe data object 510b stored on a storage tape, performing the command requires at least loading the tape into a tape reader, rewinding/fastforwarding the tape reader to the storage location associated with the requested data object 510b, and retrieving the requested data object 510b. In contrast, when the second mainframe data object 510b is stored in a disk drive, performing the command does not necessarily require loading the disk, and rewinding/fastforwarding to the storage location.

According to an embodiment, the external device access handler component 328 can be configured to determine that the identified storage device 501a is one of a plurality of device types based, for example, on the information identifying the physical storage device 510b and/or any other information indicating the device type. Once the device type is determined, the external device access handler component 328 can select a set of instructions corresponding to the command and associated with the determined device type. The selected set of instructions can then be transmitted to the identified storage device 501a for processing.

According to an embodiment, the selected set of instructions can be transmitted to the identified storage device 501a via a logical channel 316 connecting the external device access handler component 328 to the physical mainframe storage device 501a. In an embodiment, the service control manager component 318 can be invoked to determine whether an existing logical channel is active and if so, whether it is configured to transmit the selected set of instructions. If a suitable logical channel is not available, the service control manager component 318 can be configured to activate a logical channel 316 instance and to configure it to perform the desired function. In an embodiment, the logical channel 316 includes a channel API (not shown) that can be configured to facilitate communications between the external device access handler component 328 and the physical mainframe storage device 501a. Accordingly, the channel API can facilitate the transmission of the set of instructions from the external device access handler component 328 and the physical mainframe storage device 501a, and the transmission of data objects 510 from the physical mainframe storage device 501a to the external device access handler component 328.

According to an embodiment, the second request for access can include a command to read the second mainframe data object 510b. In this case, the external device access handler component 328 can retrieve the data object 510b and to return it to the file access manager component 320. In an embodiment, the second mainframe data object 510b can be retrieved by transmitting the appropriate set of instructions corresponding to the command and the storage location associated with the second mainframe data object 510b to the identified physical mainframe storage device 501a, which can be configured to fetch and return the data object 510b to the external device access handler component 328. When the data object 510b is received, it can be returned to the file access manager component 320.

As previously described, the retrieved second mainframe data object 510b is formatted in a mainframe format. Accordingly, when the file access manager component 320 receives a data object from the external device access handler component 328, e.g., the retrieved second mainframe data object 510b, the format converter 322 in the file access manager component 320 can convert the data object 510b from its native mainframe format to a second format compatible with the non-mainframe computing environment of the client node 500. Once the second mainframe data object 510b is converted, the file access manager component 320 can be configured to generate a second request result 324 including the converted second mainframe data object 510b and to transmit the second request result 324 to the client node via the network 504, as described above.

Alternatively or in addition, in an embodiment, the converted second mainframe data object 510′ can be stored in a non-mainframe storage structure, e.g., data store 350, supported by the server node 502 and/or located in another network device node (not shown). In an embodiment, the file system index 400 can also be updated to include a storage location associated with the converted second mainframe data object 510′ stored in the non-mainframe storage structure 350.

By storing the converted mainframe data object 510′ in the data store 350, archived mainframe data objects 510 on legacy storage devices 501a, 501b can be migrated off of the physical storage device and onto a non-mainframe computing platform for future consumption. Moreover, subsequent requests from the client node 500 for the corresponding mainframe data object, e.g., the second mainframe data object 510b, can be performed more efficiently because accessing the physical mainframe storage device 501a is not required.

For example, in another embodiment, when a third message 520 from the client node 500 that includes a request for access to the second mainframe data object 510b stored in the second mounted storage device is received, the file access manager component 320 can determine that the converted data object 510′ associated with the second mainframe data object 510b is stored in the non-mainframe data store 350. Once this determination is made and the storage location in the data store 350 is determined, the file access manager component 320 can be configured to retrieve the converted data object 510′ from the data store 350, to generate a third request result including the converted mainframe data object 510′, and to transmit the third request result 324 to the client node 500 via the network 504.

In addition to the embodiments described above, the MSA service 300 can also be configured to provide additional functionality. For example, the MSA service 300 can be configured to support mirroring services that enable disk-level compatibility of certain kinds of data structures to be maintained between the virtual storage devices 312 in the storage virtualization system 310 and the non-mainframe data store 350. This provides near real time mirror imaging of the mainframe data structures to the non-mainframe community of applications.

In another embodiment, the MSA service 300 can be configured to receive and/or to store mainframe audit logs reflecting any updates or changes to mainframe data objects 510 performed or directed by the mainframe server node 503. In this embodiment, the MSA service 300 can be configured to store and use the audit logs (archival or active) as a source for updating the copy of the legacy data base onto the non-mainframe storage structure 350. Doing so specifically addresses a need for parallel, near real-time availability of mainframe legacy data stored in a formal data base structure on the mainframe system.

In other embodiments, the MSA service 300 can be configured to support System Management Facility (SMF) services by migrating SMF data from the mainframe server 503 to the non-mainframe server 502 hosting the MSA service 300 and enabling client computer nodes to access the SMF data via the network 504. By removing the SMF data from the mainframe environment, costly demands on the mainframe server 503, i.e., CPU cycles, are reduced and/or eliminated. Alternatively or in addition, the MSA service 300 can be configured to support a Virtual Tape System (VTS), a research and development testing database, and mainframe emulator services.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

Preferred embodiments are described herein, including the best mode known to the inventor for carrying out the claimed subject matter. Of course, variations of those preferred embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context. cm What is claimed is:

1. A method for providing access to mainframe data objects in a heterogeneous computing environment, the method comprising:
providing, by a server node operating in a non-mainframe computing environment, a mainframe storage appliance (MSA) service comprising a storage virtualization system for storing a first plurality of mainframe data objects in a virtual storage device, wherein the first plurality of mainframe data objects is managed by a mainframe server node communicatively coupled to the server node and to a physical mainframe storage device configured for operating in a mainframe computing environment and for storing a second plurality of mainframe data objects, and wherein the virtual storage device in the storage virtualization system appears as a second physical mainframe storage device to the mainframe server node;
receiving, by the server node, a message from a client node operating in a non-mainframe computing environment and communicatively coupled to the server node via a network, wherein the virtual storage device in the storage virtualization system appears as a mounted storage drive to the client node, and wherein the message includes a request for access to at least one of the mounted storage drive and a first mainframe data object stored in the mounted storage drive;
processing, by the server node, the request for access from the client node to generate a request result in a format compatible with the non-mainframe computing environment; and
transmitting, by the server node, the request result to the client node via the network.

2. The method of claim 1 wherein the non-mainframe computing environment is at least one of a desktop computing environment, a mobile computing environment, and a cloud computing environment, and wherein the network is a TCP/IP network.

3. The method of claim 1 wherein the virtual storage device represents one of a disk drive, a tape drive, a printer, a terminal, and any device that can be configured to be at least one of a storage and output device.

4. The method of claim 1 wherein providing the MSA service comprises:
establishing, by the server node, a logical channel through which data to and from the storage virtualization system travels from and to the mainframe server node;
receiving, by the server node, a mainframe command from the mainframe server node, the command relating to a second mainframe data object;
routing the mainframe command to a virtual device manager component associated with the virtual storage device by the logical channel; and
processing the mainframe command to one of store and retrieve the second mainframe data object in and from the virtual storage device.

5. The method of claim 1 wherein providing the MSA service includes generating a file system index comprising information identifying at least one of the virtual storage device, each of the first plurality of mainframe data objects, a storage location of the virtual storage device and a storage location of each mainframe data object in the storage virtualization system, and information correlating the mounted storage drive to the virtual storage device.

6. The method of claim 5 wherein the message from the client node includes information identifying at least one of the mounted storage drive and the first mainframe data object, and wherein processing the request includes identifying a storage location associated with at least one of the virtual storage device corresponding to the mounted storage drive and the first mainframe data object based on the file system index and on the identifying information included in the message.

7. The method of claim 6 wherein the request for access includes a command, and wherein processing the request further includes locating at least one of the virtual storage drive corresponding to the mounted storage drive and the first mainframe data object based on the identified storage location, and performing the command.

8. The method of claim 6 wherein when the request for access includes a command to read the first mainframe data object, processing the request further includes:
retrieving the first mainframe data object from the identified storage location;
converting the retrieved first mainframe data object from a first format compatible with the mainframe computing environment to a second format compatible with the non-mainframe computing environment; and
including the converted first mainframe data object in the request result.

9. The method of claim 6 wherein when the message including the request also includes an updated data object and the request for access includes a command to replace the first mainframe data object with the updated data object, processing the request further includes:
extracting the updated data object from the message, wherein the updated data object is formatted in a second format compatible with the non-mainframe computing environment;
converting the updated data object from the second format to a first format compatible with the mainframe computing environment; and
replacing the first mainframe data object with the converted updated data object.

10. The method of claim 5 wherein when the physical mainframe storage device storing the second plurality of mainframe data objects is communicatively coupled to the server node, the physical mainframe storage device appears as a second mounted storage drive to the client node and wherein the file system index further comprises information identifying at least one of the physical mainframe storage device, each of the second plurality of mainframe data objects, a storage location of the physical mainframe storage device, and a storage location of each of the second plurality of mainframe data objects, and information correlating the second mounted storage drive to the physical mainframe storage device.

11. The method of claim 10 further comprising:
receiving, by the server node, a second message from the client node via the network, the message including a request for access to at least one of the second mounted storage drive and a second mainframe data object stored in the second mounted storage drive, wherein the second message from the client node includes information identifying at least one of the second mounted storage drive and the second mainframe data object; and
identifying the physical mainframe storage device corresponding to the second mounted storage drive and identifying a storage location associated with at least one of the identified physical mainframe storage device and the second mainframe data object based on the file system index and on the identifying information included in the message.

12. The method of claim 11 wherein the second request for access includes a command, and wherein the method further includes:
determining that the identified physical mainframe storage device is one of plurality of storage device types;
selecting a set of instructions corresponding to the command and associated with the determined storage device type; and
transmitting the selected set of instructions to the identified physical mainframe storage device for processing.

13. The method of claim 12 wherein transmitting the selected set of instructions to the identified physical mainframe storage device comprises:
establishing, by the server node, a logical channel through which data to and from the storage virtualization system travels from and to the identified physical mainframe storage device, wherein the selected set of instructions is transmitted to the identified physical mainframe storage device via the logical channel.

14. The method of claim 11 wherein when the second request for access includes a command to read the second mainframe data object, the method further includes:
retrieving the second mainframe data object from the identified physical mainframe storage device using the storage location associated with the second mainframe data object;
converting the retrieved second mainframe data object from a first format compatible with the mainframe computing environment to a second format compatible with the non-mainframe computing environment;
generating a second request result including the converted second mainframe data object; and
transmitting the second request result to the client node via the network.

15. A system for providing access to mainframe data objects in a heterogeneous computing environment, the system comprising:
a processor-based mainframe storage appliance (MSA) service operating in a non-mainframe computing environment on a server node and comprising a storage virtualization system for storing a first plurality of mainframe data objects in a virtual storage device, wherein the first plurality of mainframe data objects is managed by a mainframe server node communicatively coupled to the server node and to a physical mainframe storage device configured for operating in a mainframe computing environment and for storing a second plurality of mainframe data objects, and wherein the virtual storage device in the storage virtualization system appears as a second physical mainframe storage device to the mainframe server node; and
a processor-based file access manager component operating in the non-mainframe computing environment on the server node and configured for receiving a message from a client node operating in a non-mainframe computing environment and communicatively coupled to the server node via a network, wherein the virtual storage device in the storage virtualization system appears as a mounted storage drive to the client node, and wherein the message includes a request for access to at least one of the mounted storage drive and a first mainframe data object stored in the mounted storage drive, for processing the request for access from the client node to generate a request result in a format compatible with the non-mainframe computing environment, and for transmitting the request result to the client node via the network.

16. A machine-readable medium carrying one or more sequences of instructions for providing access to mainframe data objects in a heterogeneous computing environment, which instructions, when executed by one or more processors, cause the one or more processors to carry out the steps of:
providing, by a server node operating in a non-mainframe computing environment, a mainframe storage appliance (MSA) service comprising a storage virtualization system for storing a first plurality of mainframe data objects in a virtual storage device, wherein the first plurality of mainframe data objects is managed by a mainframe server node communicatively coupled to the server node and to a physical mainframe storage device configured for operating in a mainframe computing environment and for storing a second plurality of mainframe data objects, and wherein the virtual storage device in the storage virtualization system appears as a second physical mainframe storage device to the mainframe server node;
receiving, by the server node, a message from a client node operating in a non-mainframe computing environment and communicatively coupled to the server node via a network, wherein the virtual storage device in the storage virtualization system appears as a mounted storage drive to the client node, and wherein the message includes a request for access to at least one of the mounted storage drive and a first mainframe data object stored in the mounted storage drive;
processing, by the server node, the request for access from the client node to generate a request result in a format compatible with the non-mainframe computing environment; and
transmitting, by the server node, the request result to the client node via the network.

17. A method of providing access to mainframe data objects in a heterogeneous computing environment, the method comprising:
providing, by a server node operating in a non-mainframe computing environment, a mainframe storage appliance (MSA) service comprising a data store for storing a plurality of non-mainframe formatted data objects, wherein the plurality of non-mainframe formatted data objects are related to at least a portion of a plurality of mainframe formatted data objects stored in a physical mainframe storage device communicatively coupled to the server node, the physical mainframe storage device configured for operating in a mainframe computing environment;
receiving, by the server node, a message from a client node operating in a non-mainframe computing environment and communicatively coupled to the server node via a network, wherein the physical mainframe storage device appears as a mounted storage drive to the client node, and wherein the message includes a request for access to at least one of the mounted storage drive and a first mainframe data object stored in the mounted storage drive;
processing, by the server node, the request for access from the client node to generate a request result in a format compatible with the non-mainframe computing environment; and
transmitting, by the server node, the request result to the client node via the network.

18. The method of claim 17 wherein the plurality of mainframe formatted data objects stored in the physical mainframe storage device is archived mainframe data objects.

19. The method of claim 17 wherein the request for access includes a command and wherein processing the request includes:
determining that the physical mainframe storage device is one of plurality of storage device types;
selecting a set of instructions corresponding to the command and associated with the determined storage device type; and
transmitting the selected set of instructions to the identified physical mainframe storage device for processing.

20. The method of claim 19 wherein processing the request further includes receiving the first mainframe data object from the physical mainframe storage device, converting the first mainframe data object from a first format compatible with the mainframe computing environment to a second format compatible with the non-mainframe computing environment, and generating the request result including the converted mainframe data object.
